(19) United States
(12) Patent Application Publication
(10) Pub. No.: US 2011/0084049 A1
(43) Pub. Date: Apr. 14, 2011

(54) Multipurpose Track and Radius Plate Burner Apparatus

(76) Inventor: John Nash, Magnolia, TX (US)

(21) Appl. No.: 12/996,590

(22) PCT Filed: Jun. 6, 2008
(86) PCT No.: PCT/US08/66080

§ 371 Date: Dec. 6, 2010

(51) Int. Cl. B23K 9/00

(52) U.S. Cl. 219/121.48

(57) ABSTRACT

A multipurpose track and radius plate burner apparatus that permits beveled and nonbeveled burning in a workpiece is provided. The apparatus provides capability to make circle or radius burns as well as track or straight line burns. The apparatus may be used with all standard torch heads as well as mini torches. The apparatus has other applications, including making burns in corners or restricted areas, use as a protractor and use as trammel points.

### FEDERALLY SPONSORED RESEARCH

Not applicable.

### REFERENCE TO MICROFICHE APPENDIX

Not applicable.

### FIELD OF THE INVENTION

This invention relates to an apparatus for controlling the movement of a cutting torch with respect to a workpiece.

### BACKGROUND OF THE INVENTION

Previously, circle burners have been limited in that there are well-understood, practical limits to the sizes and shapes of the cuts produced by the devices. For example, most known hand-tool type circle burners create only straight cuts of either nine inches or fifteen inches, and lack the capacity to bevel the boundary surface of the plate being modified. Moreover, the smallest diameter burn is only around two inches, and the device is fitted with a number of ball bearings in the tip head, which, when heated, tend to become fouled and impair the functionality of the device.

While commercial units are available to create beveled cuts, they are very large and bulky, and are also very expensive as compared to the hand tool variety. For example, a known circle burner capable of creating beveled cuts exists in which the apparatus is several feet tall and weighs between sixty-five pounds and one hundred pounds. The device currently sells for around two thousand dollars.

Accordingly, Applicant has invented a new and non-obvious hand tool that incorporates some of the beneficial features of the larger, stand-alone units, in a manner in which welders and other operators can quickly, easily and accurately cut plate steel, plate metal, metal sheet and the like, so that the resulting port is smooth around the edges, very nearly uniformly circular, and beveled using either an inside or outside cutting technique.

The invention at its core comprises an adjustable pivoting member and a cutting tip. In a preferred embodiment, however, the system includes both an adjustable torch stabilizer and an adjustable leveling member, so that the welder's torch is held steady, and the entire device is securely and reliably stabilized while cuts are being burned.

### SUMMARY OF THE INVENTION

Embodiments of the invention provide a multipurpose plate burner apparatus having a main shaft; a first locking sleeve movably attached to the main shaft having a receiving channel disposed offset from the main shaft; a pivot adjustably disposed in the receiving channel of the first locking sleeve; a torch saddle movably attached to the main shaft; a second locking sleeve movably attached to the main shaft having a receiving channel disposed offset from said shaft; an object adjustably disposed in the receiving channel of the second locking sleeve; and a torch tip mount attached to one end of the main shaft. The object disposed in the receiving channel of the second locking sleeve may be selected from an offset pivot arm having an offset pivot point, a leveling wheel, a trammel point, or a soapstone holder. In some embodiments, the shaft has two two-foot sections and one one-foot section and further comprising means for fitting the sections together. In some embodiments, the first locking sleeve has a first channel for receiving the main shaft and a second channel disposed substantially perpendicular to the first channel for receiving the pivot. In other embodiments, the pivot is a ball point leveling stem and the object disposed in the receiving channel of the second locking sleeve is an offset pivot arm having an offset pivot point.

Another embodiment of the invention provides a multipurpose plate burner apparatus having a main shaft; a first locking sleeve movably attached to the main shaft having a substantially circular receiving channel disposed offset from the main shaft; a round pivot having a circular shaft and a stop, disposed in the receiving channel of the first locking sleeve; a torch saddle movably attached to the main shaft; a second locking sleeve movably attached to the main shaft having a receiving channel disposed offset from said shaft; an object adjustably disposed in the receiving channel of the second locking sleeve; and a torch tip mount attached to one end of the main shaft. The object disposed in the receiving channel of the second locking sleeve may be a pivot arm having an offset pivot point, a leveling wheel, a trammel point, or a soapstone holder. In some embodiments, the shaft is two two-foot sections and one one-foot section and means for fitting the sections together.

In another embodiment of the invention, a multipurpose plate burner apparatus is provided having a main shaft; a first locking sleeve movably attached to the main shaft having a receiving channel disposed offset from the main shaft; a pivot disposed in the receiving channel of the first locking sleeve; a second locking sleeve movably attached to the main shaft having a receiving channel disposed offset from said shaft; a leveling wheel adjustably disposed in the receiving channel of the second locking sleeve; a right-hand-left-hand angled torch head sleeve comprising a main channel for receiving the main shaft, and first and second receiving channels, each receiving channel disposed at an angle to the main channel; and a torch nozzle holder mounted in the first or second receiving channel. In some embodiments, the shaft has two two-foot sections and one one-foot section and means for fitting the sections together.

In yet another embodiment of the invention, a multipurpose plate burner apparatus is provided having a main shaft; a first locking sleeve movably attached to the main shaft having a substantially circular receiving channel disposed offset from the main shaft; a round pivot comprising a circular shaft and a stop, disposed in the receiving channel of the first locking sleeve; a track sleeve comprising a channel for receiving the main shaft and a receiving channel; a torch nozzle holder mounted in the receiving channel of the track sleeve; and a table support having a flat surface and a sleeve for receiving the main shaft. In some embodiments, the receiving channel is perpendicular to the channel for receiving the main shaft. In other embodiments, the receiving channel is disposed at an angle to the channel for receiving the main shaft.

### BRIEF DESCRIPTION OF THE DRAWINGS

FIG. 1A shows a schematic side view of a first embodiment of the invention, showing a configuration for unbeveled circle or radius burning.

FIG. 1B shows a schematic side view of a second embodiment of the invention, showing a configuration for beveled circle or radius burning.

FIG. 1C shows a schematic side view of a third embodiment of the invention, showing a configuration for circle burning in the presence of a corner or obstacles.

FIG. 2 shows a detailed perspective view of an embodiment of the main shaft 1 used in some embodiments of the invention.

FIG. 3A shows a detailed perspective view of a locking sleeve used in some embodiments of the invention.

FIG. 3B shows a detailed perspective view of a pivot arm sleeve used in some embodiments of the invention.

FIG. 3C shows a detailed perspective view of a torch saddle used in some embodiments of the invention.

FIG. 3D shows a detailed perspective view of an angled torch head sleeve used in some embodiments of the invention.

FIG. 4A shows a detailed perspective view of a pivot used in some embodiments of the invention.

FIG. 4B shows a detailed perspective view of a torch nozzle holder used in some embodiments of the invention.

FIG. 4C shows a detailed perspective view of a soapstone holder used in some embodiments of the invention.

FIG. 5A shows a detailed perspective view of a fourth embodiment of the invention, showing a configuration for unbeveled track burning.

FIG. 5B shows a detailed perspective view of a fifth embodiment of the invention, showing a configuration for beveled track burning.

FIG. 6 is a schematic of an alternative embodiment of the offset pivot arm and offset pivot point used in some embodiments of the invention.

### DETAILED DESCRIPTION OF EMBODIMENTS OF THE INVENTION

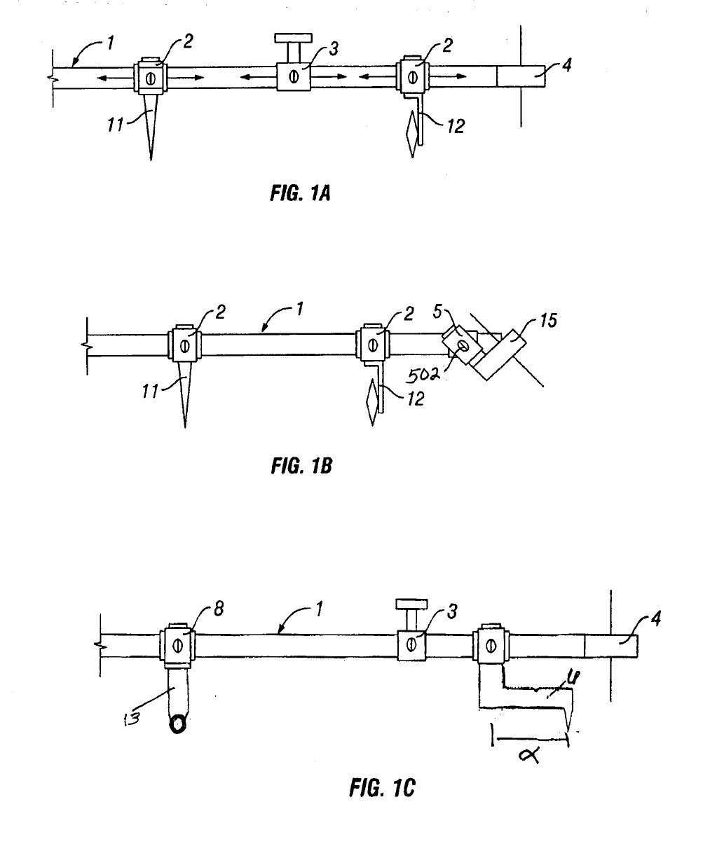

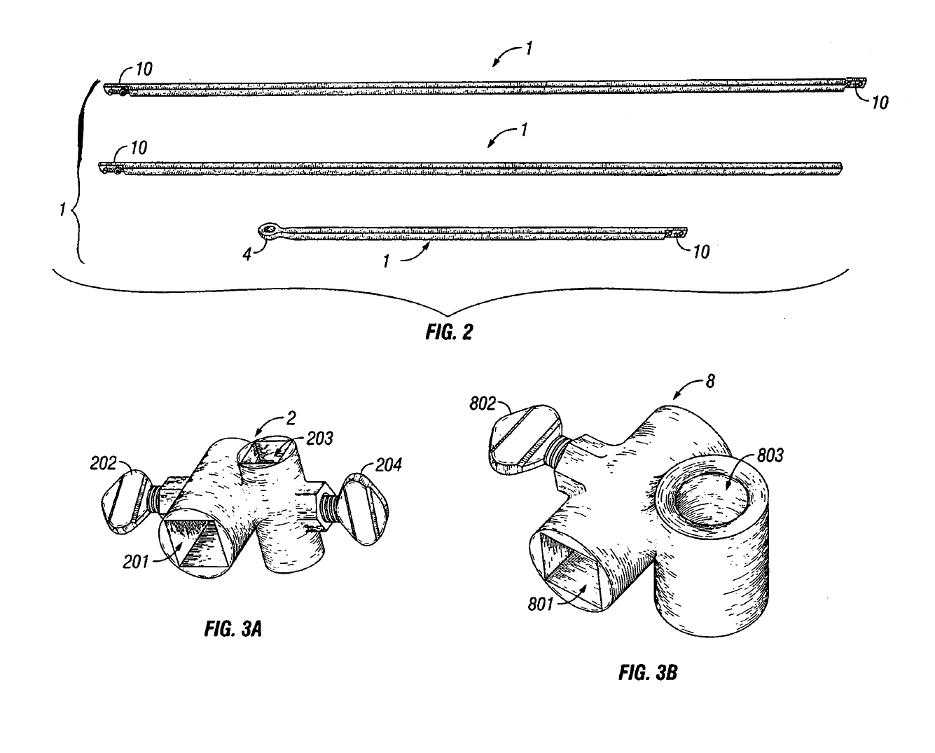

The multipurpose track and radius plate burner apparatus provides a large number of configurations in which the components may be selected in combination to configure the system to achieve one of a selection of purposes or for application in a variety of locations. Referring to FIG. 1A a first embodiment of the multipurpose track and radius plate burner apparatus is shown. As illustrated in FIG. 1A, the apparatus includes a main shaft 1 on which the remaining components of the apparatus are mounted. In a preferred embodiment, the main shaft 1 is comprised of three sections, as shown in FIG. 2, two sections each of two feet in length and one section of one foot length. The three sections are fittably attached to one another such as to provide for an unobstructed beam along the length of main shaft 1, and provided with means for fitting the beam sections together. For example, sections of main shaft 1 may be fitted together end-to-end by internally placed matching screw threads along the axis of the shaft. In another example, sections of main shaft 1 may be fitted together end-to-end by a mortice-styled configuration. In various embodiments, the main shaft may comprise only the one-foot section, the one-foot section plus one two-foot section to form a three-foot main shaft, or the one-foot section plus both two-foot sections to form a five-foot main shaft. Main shaft 1 is composed of a metal rod, typically square or octagonal in cross-section.

At one end of the one foot section of the main shaft 1 is a torch burning tip mount 4, as seen in FIG. 2. Torch burning tip mount 4 is sized to fit all standard torch burning tips. In order to use the inventive apparatus with mini torches, a bushing (not shown) having an outer diameter substantially equal to the inner diameter of the tip mount 4 may be placed inside the tip mount 4. In such embodiments, the bushing would have an inner diameter sized to fit all mini torch burning tips. As illustrated in FIG. 2, tip mount 4 is an integrated component of main shaft 1, but may also be substituted with a removable tip mount, for example, the angled torch head sleeve 5 and torch nozzle holder 15 of FIG. 1B.

Referring again to FIG. 1A, in one embodiment of the invention, the apparatus may be configured as an unbeveled circle or radius burner, typically by selecting an adjustable pivot 11 held with locking sleeve 2, a torch saddle 3, a leveling wheel 12 with a second locking sleeve 2, all mounted on shaft 1. As can be seen in FIG. 1A, burning tip mount 4 which holds the torch burning tip is located at an end of main shaft 1. A torch is placed over main shaft 1, resting upon torch saddle 3 and burning tip mount 4. The cutting nozzle of the torch fits into burning tip mount 4. In the configuration illustrated in FIG. 1A, the torch burns a hole whose edge is ninety-degrees or perpendicular to the surface of the workpiece.

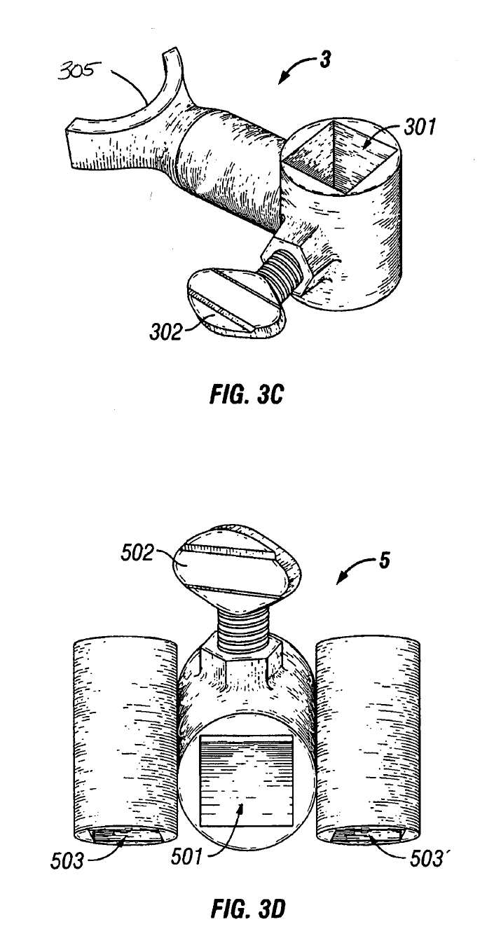

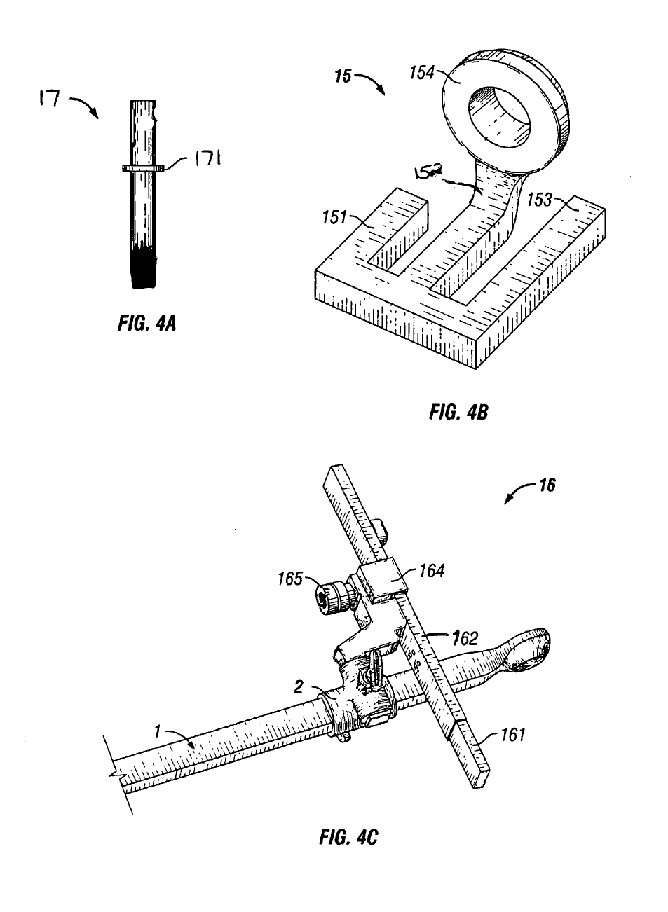

In an alternative embodiment, particularly useful for making wider radius burns, locking sleeve 2 and adjustable pivot 11 are removed and replaced with locking sleeve 8, shown in FIG. 3B, and round pivot 17, shown in FIG. 4A. In such embodiment, round pivot 17 may be tack welded to the workpiece. In a preferred embodiment, round pivot 17 includes a stop 171 so as to maintain main shaft 1 level with respect to the workpiece.

In use, the length of the radius to be cut is the distance between the centerline of the pivot point, 11 or 17, and the centerline of the tip mount 4. This distance is set and held in place by locking the locking sleeve, 2 or 8.

Referring still to FIG. 1A, the apparatus also includes leveling wheel 12 held by a second locking sleeve 2. Leveling wheel 12 may be adjusted so that the main shaft 1 is level above the workpiece and to ensure an unbeveled, ninety-degree, burn of the workpiece.

In yet another embodiment, two pivots 11 are mounted on main shaft 1, each pivot 11 attached using a locking sleeve 2. In such embodiment, one pivot 11 acts as a pivot and the other pivot 11 is used as a scribe. Alternatively the second pivot 11 may be replaced with a soapstone 161, held in place by holders later described, so as to allow the burn to be laid out prior to burning.

A second embodiment of the apparatus to burn beveled edges is shown in FIG. 1B. Specifically, the apparatus may be configured as an inside or outside diameter (I.D./O.D.) bevel burner, typically by attaching to main shaft 1 adjustable pivot 11 with a first locking sleeve 2, leveling wheel 12 with a second locking sleeve 2, and a right-hand-left-hand (R.H./L.H.) angled torch head sleeve 5. As illustrated in FIG. 1B, the apparatus is configured as a right hand outer diameter radius bevel burner. A torch nozzle holder 15 is attached to angled torch head sleeve 5 and held in place using set screw 502. Angled torch head sleeve 5 is illustrated in more detail in FIG. 3D.

To make wider radius burns having an inner or outer bevel, pivot 11 shown in FIG. 1B may be replaced with a round pivot 17 as discussed in connection with FIG. 1A.

A third embodiment of the apparatus for making radius burns in a corner of restricted area of a workpiece. As shown in FIG. 1C, the apparatus includes a ball point leveling stem 13 held within a first locking sleeve 8, torch saddle 3, and an offset pivot arm 6 held within a second locking sleeve 8. In a preferred embodiment the distance α on offset pivot arm 6 is two inches.

In the corner burner configuration, variable settings of hole radius may be made without the need to change the length of the main shaft 1. Further, guidance of the tool may be accomplished from a more convenient location, as the longer shaft can be used to control cutting of smaller diameter holes, such as in corners or underneath obstacles. The use of a ball point leveling stem for a leveler, along with the offset afforded by the offset pivot arm, in this configuration provides necessary freedom of movement to accomplish remote hole cutting capability.

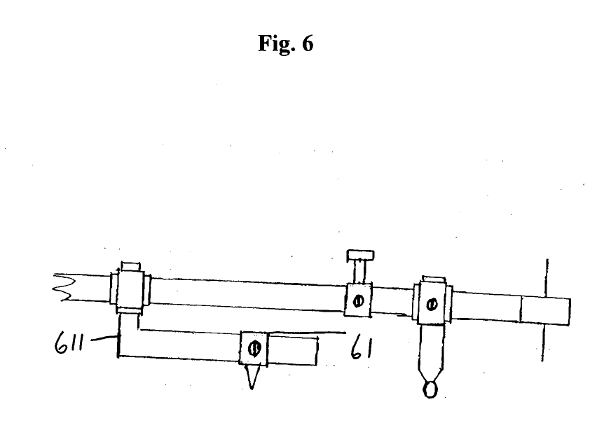

In yet another embodiment of the corner burner, an offset pivot point 61 is adjustable along the length of offset pivot arm 611, as shown in FIG. 6.

Sleeves of various configurations are illustrated in FIGS. 3A-3D. The basic locking sleeve 2, shown in FIG. 3A, comprises a channel 201 for receiving main shaft 1; a locking means, such as set screw 202, is disposed into channel 201 for the purpose of locking the position of locking sleeve 2 on shaft 1; a receiving channel 203, of orientation typically perpendicular to channel 201, for holding one of a selection of objects. Optionally, a second locking means, such as set screw 204, is disposed into channel 203 for the purpose of affixing the selected object held in receiving channel 203. Objects that may be held by locking sleeve 2 include an adjustable pivot 11 (illustrated in FIG. 1A), leveling wheel 12 (illustrated in FIG. 1A), a trammel point (not illustrated, of the nature of pivot 11), and soapstone holder 16 (illustrated in FIG. 4C). In practice, leveling wheel 12 is set to an elevation even with pivot 11 for burning or cutting a hole whose edge is ninety-degrees or perpendicular to the surface of the workpiece.

FIG. 3B illustrates a pivot arm sleeve 8, comprising a channel 801 for receiving main shaft 1; a locking means, such as set screw 802, is disposed into channel 801 for the purpose of locking the position of pivot arm sleeve 8 on shaft 1; a receiving channel 803, of orientation-typically perpendicular to channel 801. A second locking means is not provided and receiving channel 803 is circular. Receiving channel 803 allows for free rotational movement of pivot arm sleeve 8, and attached main shaft 1, about the object held in receiving channel 803. For example, a selected object, such as pivot arm 6 (FIG. 1C) or pivot 17 (illustrated in FIG. 4A), is constructed with a circular form and stop so as to fit into receiving channel 803, providing rotational mobility of main shaft 1 about the selected object.

Torch saddle 3, shown in FIG. 3C, comprises a channel 301 for receiving main shaft 1; a locking means, such as set screw 302, disposed into channel 301 for the purpose of locking the position of torch saddle 3 on main shaft 1; and a saddle portion 305 integrated into the body of torch saddle 3, such that a typical torch handle assembly may rest upon torch saddle 3.

The angled torch head sleeve 5, shown in FIG. 3D, comprises a channel 501 for receiving main shaft 1; a locking means, such as set screw 502, disposed into channel 501 for the purpose of locking the position of angled torch head sleeve 5 on main shaft 1; a pair of receiving channels 503, 503′, of orientation typically angled to channel 501, for holding one of a selection of objects, such as torch nozzle holder 15. Set screws, for example, set screw 502 of FIG. 1B, affix torch nozzle holder 15 to angled torch head sleeve 5. The angle of orientation of receiving channels 503, 503′, for example, is fifty-five degrees with respect to channel 501 in order to provide for a thirty-five degree bevel. For bevels of other degree, the orientation of receiving channels 503, 503′ may be angled to channel 501 in the amount of the desired angle of the bevel subtracted from ninety degrees. The pair of receiving channels 503, 503′ allow angled torch head sleeve 5 to be attached to main shaft 1 to provide either a right-hand or a left-hand orientation, providing for either an inside diameter bevel or an outside diameter bevel. This is accomplished simply by attaching angled torch head sleeve 5 in either a forward or reverse direction on shaft 1, and inserting torch nozzle holder 15 in either of receiving channels 503 or 503′.

Additional objects held by the sleeves, of various configurations, are illustrated in FIGS. 4A-4C. FIG. 4A illustrates a round pivot 17, shaped and configured to be rotatably received by pivot arm sleeve 8 (illustrated in FIGS. 1C and 3B). Round pivot 17 has an overall circular cross section with a wider diameter circular stop 171.

FIG. 4B illustrates torch nozzle holder 15. Torch nozzle holder 15 comprises a pair of attachment arms 151, 153; a torch head arm 152; and a torch head receptacle 154. Torch head receptacle 154 is attached to one end of torch head arm 152 and is mounted such that the torch head receptacle 154 is perpendicular to torch head arm 152. Attachment arms 151 and 153 are positioned parallel and to either side of torch head arm 152. The opposite end of torch head arm 152 is connected to one end of each of attachment arms 151 and 153. Attachment arms 151, 153 and torch head arm 152 are all coplanar with respect to perpendicularly oriented torch head receptacle 154. Attachment arm 151 is shorter than attachment arm 153, allowing for proper positioning of torch receiving orifice 154 when torch nozzle holder 15 is inserted into torch head sleeve 5, such as for beveled circle burning or cutting. Attachment arm 153 is longer than attachment arm 151, allowing for proper positioning of torch receiving orifice 154 when torch nozzle holder 15 is inserted into sleeves designed for ninety-degree or beveling and track cutting.

FIG. 4C illustrates the configuration for using the apparatus as a protractor in which soapstone holder 16 is used to hold a piece of soapstone, which may be used to provide markings on the workpiece. Soapstone 161 is inserted into hollow shaft 162, a standard commercially available soapstone holder. Hollow shaft 162 is slidable through soapstone sleeve 164 so as to allow for desired distance of the soapstone from main shaft 1. Soapstone sleeve 164 has a set screw 165 that is perpendicular to the length of hollow shaft 162, enabling the position of soapstone sleeve 164 on hollow shaft 162 to be fixed. Soapstone sleeve 164 further includes means for mounting into a locking sleeve 2. Locking sleeve 2 is attached to shaft 1 as previously described.

In another embodiment, the apparatus may be configured as a scribing device, typically by selecting an adjustable pivot with locking sleeve and a trammel point with locking sleeve, all mounted on a shaft.

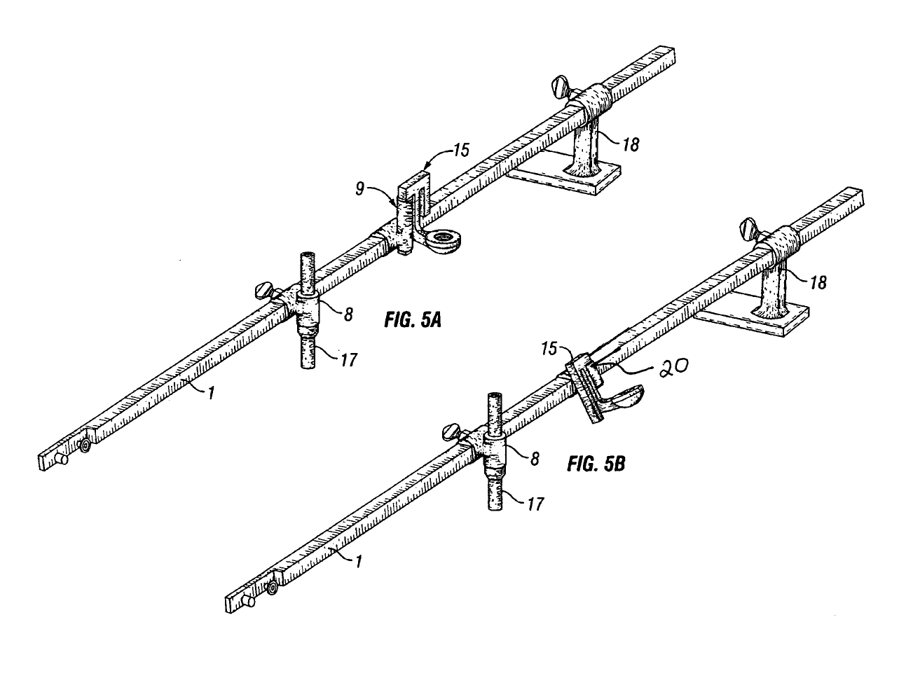

In other embodiments, the apparatus may be configured as a track burner, typically by selecting a slidable ninety-degree or bevel/angled torch sleeve, and a shaft stabilizer with locking sleeve, both mounted on a shaft. FIGS. 5A and 5B illustrate typical track burner configurations. In the track burner configurations, typically two shaft stabilizers orient the shaft along the line to be burned. By using a ninety degree or bevel torch head on a slidable sleeve, a line may be burned along the track of the shaft. A ninety-degree burn or a beveled burn may be accomplished, depending on the torch head/sleeve selection.

FIG. 5A illustrates an embodiment useful for track burning or cutting a line whose edge is ninety-degrees or perpendicular to the cutting surface of the workpiece. Main shaft 1 is supported on the workpiece by one or more, preferably two or more, stabilizers or supports. As illustrated in the embodiment shown in FIG. 5, one support is shown as round pivot 17, which is held in place by a locking sleeve 8. The other support is shown as table support 18, which has one side of a flat surface disposed on the workpiece with a sleeve for receiving main shaft 1. Track sleeve 9 has a channel for receiving main shaft 1 and a perpendicular receiving channel for receiving an attachment arm of torch nozzle holder 15. Track sleeve 9 is slidable along the length of the beam of shaft 1, between round pivot 17 and table support 18. Either or both of table support 18 and round pivot 17 may be tack welded to the workpiece. In some embodiments, a second table support 18 may be used in place of round pivot 17 held by locking sleeve 2.

FIG. 5B illustrates an example of burning or cutting a track whose edge is beveled with respect to the cutting surface of the workpiece. Main shaft 1 is supported above the workpiece by round pivot 17 held in a locking sleeve 2 and table support 18. Track sleeve 20 has a channel for receiving main shaft 1 and an angled receiving channel for receiving an attachment arm of torch nozzle holder 15. Track sleeve 20 is slidable along the length of main shaft 1, between round pivot 17 and table support 18. The shorter attachment arm of torch nozzle holder 15 is used, as track sleeve 20 is positioned lower relative to shaft 1, owing to the required change in position of the torch nozzle to effect the proper location and position for burning or cutting at the beveled angle. In some embodiments, a second table support 18 may be used in place of round pivot 17 held by locking sleeve 2.

From the foregoing illustrated examples, it can be seen that other apparatus configurations may be assembled from the described components. In one further example, the apparatus may be configured to accommodate lengths exceeding approximately one arm span, approximately five feet or greater, typically by selecting a round pivot with locking sleeve, the round pivot spot-tacked to the workpiece, leveling wheel with locking sleeve, and torch head sleeve, all mounted on a shaft. The apparatus may also be configured as a mini-burner, typically by selecting an adjustable pivot with locking sleeve, leveling wheel with locking sleeve, and a R.H./L.H. angled torch head sleeve, all mounted on a shortened, approximately one foot shaft. The mini-burner configuration can accommodate the mini-burner torch size. In still further examples, the tool system provided by the present invention burns ninety degree and bevels I.D. and O.D. on a radius. It also performs as a corner burner, burning a radius in a corner or under obstacles. As a track burner, it will burn a straight line at ninety degree or bevel. The apparatus can also be used as trammel points or as a protractor. It can also be used as a mini-burner with application of a shorter shaft, still providing the ability to burn ninety degree and bevels.

In the foregoing, the term ninety-degree as used in practice encompasses various degrees of tolerance and is to be applied as a term representing a substantially straight cut. The terms “burn”, “burner”, and “burning” are typically used in the subject art to describe the apparatus or act of cutting, marking, or depositing on, substances such as metal by the use of a heat source, such as a flame torch or electrical arc. It can be appreciated that the term “torch” may apply to heat sources such as a flame torch or arc.

The foregoing is provided for illustrative purposes only, and is not intended to describe all possible aspects of the present invention. Those of ordinary skill in the pertinent arts will appreciate that minor changes to the description, and various other modifications, omissions and additions can be made without departing from either the spirit or scope of the invention as claimed.

I claim:

1. A multipurpose plate burner apparatus comprising:
a main shaft;
a first locking sleeve movably attached to the main shaft, the first locking sleeve having a receiving channel disposed offset from the main shaft;
a pivot adjustably disposed in the receiving channel of the first locking sleeve;
a torch saddle movably attached to the main shaft;
a second locking sleeve movably attached to the main shaft, the second locking sleeve having a receiving channel disposed offset from said shaft;
an object adjustably disposed in the receiving channel of the second locking sleeve; and
a torch tip mount attached to one end of the main shaft;
wherein the object disposed in the receiving channel of the second locking sleeve is selected from the group comprising: an offset pivot arm having an offset pivot point, a leveling wheel, a trammel point, and a soapstone holder.

2. The multipurpose plate burner apparatus of claim 1 wherein said shaft is comprised of two two-foot sections and one one-foot section and further comprising means for fitting the sections together.

3. The multipurpose plate burner apparatus of claim 1 wherein the first locking sleeve comprises: a first channel for receiving the main shaft; and a second channel disposed substantially perpendicular to the first channel, the second channel for receiving the pivot.

4. The multipurpose plate burner apparatus of claim 1 wherein the pivot is a ball point leveling stem and the object disposed in the receiving channel of the second locking sleeve is an offset pivot arm having an offset pivot point.

5. A multipurpose plate burner apparatus comprising:
a main shaft;
a first locking sleeve movably attached to the main shaft, the first locking sleeve having a substantially circular receiving channel disposed offset from the main shaft;
a round pivot comprising a circular shaft and a stop, the round pivot disposed in the receiving channel of the first locking sleeve;
a torch saddle movably attached to the main shaft;
a second locking sleeve movably attached to the main shaft, the second locking sleeve having a receiving channel disposed offset from said shaft;
an object adjustably disposed in the receiving channel of the second locking sleeve; and
a torch tip mount attached to one end of the main shaft;
wherein the object disposed in the receiving channel of the second locking sleeve is selected from the group comprising: a pivot arm having an offset pivot point, a leveling wheel, a trammel point, and a soapstone holder.

6. The multipurpose plate burner apparatus of claim 5 wherein said shaft is comprised of two two-foot sections and one one-foot section and further comprising means for fitting the sections together.

7. A multipurpose plate burner apparatus comprising:
a main shaft;
a first locking sleeve movably attached to the main shaft, the first locking sleeve having a receiving channel disposed offset from the main shaft;
a pivot disposed in the receiving channel of the first locking sleeve;
a second locking sleeve movably attached to the main shaft, the second locking sleeve having a receiving channel disposed offset from said shaft;
a leveling wheel adjustably disposed in the receiving channel of the second locking sleeve;
a right-hand-left-hand angled torch head sleeve comprising a main channel for receiving the main shaft, and first and second receiving channels, each receiving channel disposed at an angle to the main channel; and
a torch nozzle holder mounted in the first or second receiving channel.

8. The multipurpose plate burner apparatus of claim 7 wherein said shaft is comprised of two two-foot sections and one one-foot section and further comprising means for fitting the sections together.

9. A multipurpose plate burner apparatus comprising:
a main shaft;
a first locking sleeve movably attached to the main shaft, the first locking sleeve having a substantially circular receiving channel disposed offset from the main shaft;
a round pivot comprising a circular shaft and a stop, the round pivot disposed in the receiving channel of the first locking sleeve;
a track sleeve comprising a channel for receiving the main shaft and a receiving channel;
a torch nozzle holder mounted in the receiving channel of the track sleeve; and
a table support comprising a flat surface and a sleeve for receiving the main shaft.

10. The multipurpose plate burner apparatus of claim 9 wherein the receiving channel is perpendicular to the channel for receiving the main shaft.

11. The multipurpose plate burner apparatus of claim 9 wherein the receiving channel is disposed at an angle to the channel for receiving the main shaft.
